(19) United States
(12) Patent Application Publication
(10) Pub. No.: US 2016/0084053 A1
(43) Pub. Date: Mar. 24, 2016

(54) Flowable Composition For The Thermal Treatment Of Cavities

(71) Applicant: WINTERSHALL HOLDING GMBH, Kassel (DE)

(72) Inventor: Vladimir Stehle, Kassel (DE)

(73) Assignee: Wintershall Holding GmbH, Kassel (DE)

(21) Appl. No.: 14/783,676

(22) PCT Filed: Apr. 9, 2014
(86) PCT No.: PCT/EP2014/057178

§ 371 Date: Oct. 9, 2015

(30) Foreign Application Priority Data
Apr. 10, 2013 (EP) 13163098.0

(51) Int. Cl. E21B 43/243; C09K 8/68; C09K 8/536; C06B 45/32

(52) U.S. Cl. CPC E21B 43/243; C06B 45/32; C09K 8/68; C09K 8/536

(57) ABSTRACT

A free-flowing composition (FC) comprises:
(A) an aqueous carrier fluid (AC) and
(B) a solid component (SC) comprising a hydroreactive metal component (MC) enveloped by a water-soluble polymer (P),
the solids component (SC) being suspended in the aqueous carrier fluid (AC).

The present invention relates to a free-flowing composition (FC) for thermal treatment of cavities, to a method for thermal treatment of cavities and to the use of the free-flowing composition (FC) for thermal treatment of cavities.

The production of fluid raw materials, for example mineral oil and/or natural gas, from geological formations, typically underground deposits, generally involves sinking at least one well into the underground deposit, through which the fluid raw material is subsequently produced.

The production rate depends to a high degree on the permeability of the reservoir rocks and the rock strata adjoining the well. The more permeable these rock strata or the reservoir rocks are, the higher the production rate of fluid raw material, for example mineral oil and/or natural gas, that can be achieved. High production rates are necessary in order that operation of underground deposits is economically viable. A crucial factor for the production rate is the hydrodynamic communication between the well and the productive stratum of the underground deposit (geological formation). The productive stratum generally refers to the stratum of the geological formation comprising the fluid raw material, for example mineral oil or natural gas.

The better the hydrodynamic communication between the well and the productive stratum of the underground deposit, the higher the production rates that can be achieved. Both in the course of developments and in the course of production of mineral oil and/or natural gas from underground deposits, a reduction in the permeability of the reservoir rock and of the rock strata adjoining the well may occur. This reduction in the permeability worsens the hydrodynamic communication, such that the production rate of mineral oil and/or of natural gas from the underground formation decreases or even stops completely.

To improve the hydrodynamic communication between the well and the productive strata of an underground deposit, the prior art describes, for example, the method of “hydraulic fracturing” (fissuring of an underground rock stratum in a geological formation or deposit). In order to increase the flow of fluids (especially mineral oil and/or natural gas) into and/or out of the underground deposit, water is injected into the underground deposit under pressure. The water, also referred to a fracture fluid, is pumped into the rock stratum to be fractured or fissured at a pressure sufficient to separate or to fracture the rock strata. This widens natural fissures and cracks present, which have been formed in the course of development of the underground rock stratum or through subsequent tectonic movements. In addition, new cracks, gaps and fissures are produced. “Hydraulic fracturing” is understood to mean the occurrence of a fracture event in the rocks surrounding a well as a result of the hydraulic action of a liquid or gas pressure on the rock in the underground deposit. The section of the well whose surrounding rock has fissures or cracks is also referred to as the perforation zone or perforation region.

However, this measure generally only achieves a short-lived improvement in hydrodynamic communication.

During the operating phase of an underground deposit comprising mineral oil and/or natural gas, high-viscosity substances are frequently deposited in the fissured rock of the perforation zone. The high-viscosity substances may be paraffins, high-viscosity oil and bitumen (asphaltenes). These high-viscosity substances block the perforation zone. This distinctly reduces the production rate of mineral oil and/or natural gas from the underground deposit. In exceptional cases, the production of mineral oil and/or natural gas may also stop completely. The above-described high-viscosity substances can also be deposited in the well or in pipelines for transport of mineral oil and/or natural gas.

In addition, slurry formation from the fissured rock strata which surround the perforation region of the well can arise in the course of sinking of wells, both in the case of production wells and in the case of injection wells, during the drilling process, and also in the course of the subsequent processes for stabilizing the well, for example cementing processes. In addition, there is a change in the stress pressure and deformation state of the rock surrounding the well. The effect of this is generally that rock zones having a higher density and lower permeability form in a cylinder around the well. This likewise leads to a reduction in the production rate of mineral oil and/or natural gas from the underground deposit.

In order to counteract the reduction in the permeability of the perforation region or to improve hydrodynamic communication between well and productive stratum, the prior art describes various methods. The best-known methods include the above-described hydraulic fracturing, and the flushing of the well with warm water or with steam. However, these methods have the disadvantage that they can lead to watering-out of the underground deposit.

The prior art additionally describes thermal treatment methods in order to improve the hydrodynamic communication between well and productive stratum.

For instance, RU 2 401 381 describes free-flowing compositions comprising aluminum particles or particles of an aluminum alloy for thermal treatment of underground deposits with the aim of improving hydrodynamic communication. In this case, the aluminum particles are suspended in an anhydrous carrier fluid and do not have a passivation layer. The aluminum particles may also comprise further alloy metals, for example tin, gallium and cadmium. The carrier fluids used are, for example, kerosene, mineral oil or gas condensate. The free-flowing composition may additionally comprise proppants.

The free-flowing composition is injected into the underground deposit. Subsequently, the aluminum present in the free-flowing composition is contacted with water in order to initiate the oxidation reaction between aluminum and water. For this purpose, water is injected subsequently into the underground formation. The exothermic oxidation reaction gives rise to heat, and gases form. The evolution of heat and gas in conjunction with the associated rise in pressure results in dissolution of deposits in the underground deposit, as a result of which hydrodynamic communication between the productive stratum and the well is improved.

The free-flowing composition described in RU 2 401 381 comprises an anhydrous carrier fluid in order to prevent the spontaneous oxidation reaction of the aluminum above ground. The aluminum particles are protected from contact with water and/or atmospheric oxygen by the anhydrous carrier fluid. A disadvantage of this method is that the anhydrous carrier fluids used are hydrophobic. This hinders the contact of the aluminum particles with water. This is problematic especially when the free-flowing composition of RU 2 401 381 is injected into narrow cracks, called “fracks”. In such fracks, the speed of the subsequently injected water is very low, and so the oxidation reaction between aluminum and water can be hindered.

Furthermore, the free-flowing composition can also penetrate into rock pores which are not reached at all by the water injected subsequently. In this case, no oxidation reaction of the aluminum particles take place. In this case, the use of the free-flowing composition according to RU 2 401 381 is actually counterproductive, since the aluminum particles introduced block the rock pores in this case, as a result of which a decrease in the permeability and hence a deterioration in hydrodynamic communication occur.

In order to prevent a spontaneous oxidation reaction above ground, it is necessary in the method according to RU 2 401381 to work under anhydrous conditions. This makes the method inconvenient and costly, since it is necessary to rule out any presence of water, for example in the form of emulsified water droplets, in the kerosene, mineral oil or gas condensate used as the anhydrous carrier fluid. A further disadvantage of the free-flowing composition according to RU 2 401 381 is that, as described above, the subsequently injected water under some circumstances does not react fully with the aluminum particles present in the free-flowing composition. This can result in watering-out of the underground deposit. In this way too, a reduction in the permeability of the underground deposit is brought about.

U.S. Pat. No. 7,946,342 discloses the thermal treatment of an underground deposit. For this purpose, an aqueous mixture comprising alkali metals, alkaline earth metals or metal hydrides ensheathed with a water-soluble coating is introduced into a well and undergoes an exothermic reaction with the water therein once the water-soluble coating has dissolved. The exothermic reaction gives rise to heat and gases are formed. These are transferred into the deposit and hence the viscosity of the mineral oil is reduced, which enables improved production of the mineral oil. A disadvantage of the method described in U.S. Pat. No. 7,946,342 is the high thermal stress on the well as a result of the exothermic chemical reaction.

U.S. Pat. No. 2,672,201 likewise describes a process in which an underground deposit is treated thermally with sodium or potassium. The alkali metal is introduced into the deposit either as a slurry in an inert liquid or ensheathed with a water-soluble coating. If the alkali metal is introduced into the underground deposit as a slurry, it is necessary thereafter to inject water with which the metal reacts exothermically. Alkali metals ensheathed by a water-soluble coating are introduced into the deposit in an aqueous solution and react exothermically with the water as soon as the coating has dissolved.

The alkali metals and alkaline earth metals described in U.S. Pat. No. 7,946,342 and U.S. Pat. No. 2,672,201 are highly reactive. Therefore, the mixtures are difficult to handle and storage entails complex safety measures. This makes the methods described very inconvenient and costly. The injection of the alkali metals in an inert fluid additionally requires subsequent injection of water in order to initiate the exothermic reaction. Since the carrier fluids used are hydrophobic, contact of the metal particles with water is hindered. If water does not react fully with the particles, the result may be watering out of the deposit.

The WO 2014/049021 describes a method in which a free-flowing composition comprising aluminum particles, water and urea is used. The aluminum particles according to WO 2014/049021 have a passivation layer consisting of aluminum oxide and/or aluminum hydroxide. This passivation layer slows the oxidation reaction of the aluminum with water. The free-flowing composition is injected into an underground deposit.

The passivation layer dissolves gradually in the underground deposit. After the dissolution of the passivation layer, the actual exothermic oxidation reaction between aluminum and water sets in. As a result of the heat released, deposits in the underground deposit are dissolved and the hydrodynamic communication is improved.

The free-flowing composition described in the WO 2014/049021 has the advantage over the free-flowing composition described in RU 2 401 381 that the common injection of aluminum particles and water reliably ensures that the oxidation reaction of aluminum with water takes place, and that, in addition, the amount of water used can be matched better to the amount of aluminum used, such that watering-out of the underground deposit can be reduced or prevented.

Nevertheless, there is still room for improvement in the free-flowing compositions described in WO 2014/049021. The aluminum particles present in the free-flowing composition according to WO 2014/049021 have a passivation layer. These passivation layers may be of different thickness. Because of the different thicknesses of the passivation layers, the period within which the passivation layer is dissolved and the oxidation reaction between aluminum and water sets in cannot be predicted reliably.

It is thus an object of the present invention to provide a free-flowing composition (FC) which has the disadvantages described above in the prior art only to a reduced degree, if at all. The free-flowing composition (FC) is to be processable reliably. More particularly, the oxidation reaction between the metal component used and water is to take place reliably, and more exact matching of the amount of water to the amount of the metal component used is to be enabled. In addition, the period of time within which the oxidation reaction between the water present in the aqueous carrier fluid and the metal component used sets in is to be more accurately predictable. The free-flowing composition (FC) is to be introducible reliably into cavities. More particularly, a spontaneous uncontrolled onset of the oxidation reaction between water and the metal component used is to be prevented.

This object is achieved by a free-flowing composition (FC) comprising (A) an aqueous carrier fluid (AC) and (B) a solid component (SC) comprising a hydroreactive metal component (MC) enveloped by a water-soluble polymer (P), the solid component (SC) being suspended in the aqueous carrier fluid (AC).

The inventive free-flowing composition (FC) is suitable for thermal treatment of cavities. “Free-flowing” in this context means that the free-flowing composition (FC) can be pumped by means of conventional pumps. The cavities which can be thermally treated with the free-flowing composition (FC) may, for example, be cavities in a geological formation, preferably cavities in underground deposits. The cavities may be of natural origin or may have been artificially produced. Examples of cavities of natural origin are cavities which have resulted from geotectonic processes, or from dissolution and washing-out of particular minerals in a geological formation.

Examples of artificially produced cavities are wells and pipelines, and also cracks which have been produced in the geological formation by processes such as “hydraulic fracturing” (fissuring of an underground rock stratum in a geological formation or deposit) or thermal processes, such as thermite reactions or explosions. Artificially produced cavities are additionally cavities which are formed in a geological formation as a result of production processes. Such production processes may, for example, be the production of mineral oil, natural gas, groundwater, coal, minerals and ores. The artificially produced cavities may additionally be formed by burnoff or gasification of raw materials, for example coal in a geological formation.

Cavities which can be treated with the free-flowing composition (FC) are, for example, pipelines, wells or cavities in underground deposits, for example shale gas deposits, tight gas deposits, shale oil deposits, oil deposits with dense reservoir rock, bitumen and heavy oil deposits, coal deposits, ore deposits and groundwater deposits.

The thermal treatment of the cavities with the free-flowing composition (FC) can, for example, remove deposits from these cavities. In addition, it is possible to form new cavities in the geological formation through the thermal treatment with the free-flowing composition (FC). The evolution of heat and gas which occurs in the course of thermal treatment, in conjunction with the pressure which arises, can result in the formation of further cracks in the geological formation or underground deposits.

The deposits may, for example, be high-viscosity substances such as paraffins, high-viscosity mineral oils or bitumen (asphaltenes). The inventive free-flowing composition (FC) is particularly suitable for thermal treatment of cracks and fissures in underground formations which have been formed by hydraulic fracturing, and in the case of which a decrease in the permeability as a result of the deposition of the aforementioned high-viscosity substances has been registered later in the mineral oil or natural gas production. With the aid of the inventive free-flowing composition (FC), it is possible to effectively remove the above-described high-viscosity substances from the cracks and fissures which have formed as a result of the hydraulic fracturing. In addition, it is possible to use the inventive free-flowing composition (FC) to produce new fissures or cracks. With the aid of the free-flowing composition (FC), an effective increase in the permeability of the perforation zone and an effective improvement of the communication between productive stratum and well is thus possible.

The free-flowing composition can be used, for example, for stimulation of wells, fracking of rock formations in deposits, detonation of combustible geological materials such as coal, mineral oil or natural gas and other combustible or explosive substances, and for cleaning of wells and pipelines.

The free-flowing composition (FC) has the advantage over the free-flowing compositions described in the prior art that the exothermic oxidation reaction between the hydroreactive metal component (MC) and the water present in the aqueous carrier fluid (AC) is reliably assured. The free-flowing composition (FC) additionally has the advantage that the period within which the oxidation reaction between the water in the carrier fluid and the hydroreactive metal component (MC) sets in can be planned more accurately. The free-flowing composition (FC) is additionally inexpensive through the use of an aqueous carrier fluid (AC) and is easy to produce.

In one embodiment, the inventive free-flowing composition is not a thermite composition. Thermite compositions are compositions which have a metal as a fuel component and an oxide of a metal other than the fuel component as an oxidizing agent, for example iron oxide and aluminum.

As component (A), the inventive free-flowing composition (FC) comprises an aqueous carrier fluid (AC). The aqueous carrier fluid (AC) used may be water itself or a mixture of water with other solvents, for example glycerol. The aqueous carrier fluid (AC) may additionally comprise further additives in dissolved form.

Additives which may optionally be present in dissolved form in the aqueous carrier fluid (AC) are, for example, thickeners, surfactants, urea, oxidizing agents, acids and alkalis.

Suitable thickeners are, for example, synthetic polymers such as polyacrylamide or copolymers of acrylamide and other monomers, especially monomers having sulfo groups, and polymers of natural origin, for example glycosylglucans, xanthan, diutans or glucan. The preferred thickener is glucan. The use of thickeners allows the viscosity of the free-flowing composition (FC) to be increased, in order to prevent sedimentation of the solid component (SC) and of any proppant (PP) present. The content of thickeners in the aqueous carrier fluid (AC) may generally be in the range from 0.01 to 5% by weight, based on the total weight of the aqueous carrier fluid (AC).

The viscosity of the free-flowing composition (FC) is generally in the range from 100 to 1500 mPa*s, preferably in the range from 200 to 1000 mPa*s and more preferably in the range from 300 to 800 mPa*s. It will be appreciated that the free-flowing composition (FC) may also have higher or lower viscosities.

The surfactants used may be anionic, cationic and nonionic surfactants.

Commonly used nonionic surfactants are, for example, ethoxylated mono-, di- and trialkylphenols, ethoxylated fatty alcohols and polyalkylene oxides. In addition to the unmixed polyalkylene oxides, preferably C₂-C₄-alkylene oxides and phenyl-substituted C₂-C₄-akylene oxides, especially polyethylene oxides, polypropylene oxides and poly(phenylethylene oxides), particularly suitable are block copolymers, especially polymers having polypropylene oxide and polyethylene oxide blocks or poly(phenylethylene oxide) and polyethylene oxide blocks, and also random copolymers of these alkylene oxides. Such alkylene oxide block copolymers are known and are commercially available, for example, under the Tetronic and Pluronic names (BASF).

Customary anionic surfactants are, for example, alkali metal and ammonium salts of alkyl sulfates (alkyl radical: C₈-C₁₂), of sulfuric monoesters of ethoxylated alkanols (alkyl radical: C₁₂-C₁₈) and ethoxylated alkylphenols (alkyl radicals: C₄-C₁₂) and of alkylsulfonic acids (alkyl radical: C₁₂-C₁₈).

Suitable cationic surfactants are, for example, the following salts having C₆-C₁₈-alkyl, alkylaryl or heterocyclic radicals: primary, secondary, tertiary or quaternary ammonium salts, pyridinium salts, imidazolinium salts, oxazolinium salts, morpholinium salts, propylium salts, sulfonium salts and phosphonium salts. Examples include dodecylammonium acetate or the corresponding sulfate, disulfates or acetates of the various 2-(N,N,N-trimethylammonium)ethylparaffinic esters, N-cetylpyridinium sulfate and N-laurylpyridinium salts, cetyltrimethylammonium bromide and sodium laurylsulf ate. The content of surfactant in the aqueous carrier fluid (AC) may generally be in the range from 0.01 to 5% by weight, based on the total weight of the aqueous carrier fluid (AC).

In addition, the aqueous carrier fluid (AC) may comprise urea or ammonium salt (such as ammonium nitrate) in dissolved form. In this case, the urea is in dissolved form in the aqueous carrier fluid (AC). If urea is used, the urea is generally dissolved in the aqueous carrier fluid (AC) in such amounts that the free-flowing composition (FC) comprises 5 to 40% by weight of urea, based on the total weight of the free-flowing composition (FC). In one embodiment, the free-flowing composition (FC) comprises 10 to 40% by weight of urea, based on the total weight of the free-flowing composition (FC).

If urea is used, urea is converted by hydrolysis in the presence of water to ammonia and carbon dioxide. The hydrolysis follows the following reaction equation:

H₂N—CO—NH₂+H₂O→2NH₃+CO₂

The use of urea can thus increase the amount of gas which is generated by the free-flowing composition (FC). As a result of the hydrolysis of the urea, the pH of the aqueous carrier fluid (AC) rises, since the ammonia has good solubility in water. The alkali which forms directly in the deposit promotes the dissolution of the water-soluble polymer (P) and promotes the oxidation reaction between the hydroreactive metal component (MC) and the water in the aqueous carrier fluid (AC).

If urea is used, the aqueous carrier fluid (AC) used may, for example, also directly be a 32.5% by weight aqueous urea solution. Such aqueous urea solutions are available, for example, under the “Ad Blue®” trade name from BASF SE.

The aqueous carrier fluid (AC) may additionally comprise oxidizing agents in dissolved form. Suitable oxidizing agents are, for example, ammonium nitrate, ammonium perchlorate, sodium perchlorate, potassium perchlorate and hydrogen peroxide, preference being given to ammonium nitrate. If the free-flowing composition (FC) comprises an oxidizing agent, the oxidizing agent is generally dissolved in the aqueous carrier fluid (AC) in such amounts that the free-flowing composition (FC) comprises 1 to 30% by weight, preferably 10 to 20% by weight, of oxidizing agent, preferably ammonium nitrate, based in each case on the total weight of the free-flowing composition (FC).

The aqueous carrier fluid (AC) used may also be an aqueous solution comprising ammonium niter (ammonium nitrate). This significantly increases the amount of heat released in the oxidation reaction.

The aqueous carrier fluid (AC) may additionally comprise acids or alkalis. These may be used to set the pH of the free-flowing composition (FC). Suitable acids are, for example, nitric acid, sulfuric acid and hydrochloric acid, preference being given to hydrochloric acid. Suitable alkalis are, for example, sodium hydroxide and potassium hydroxide.

The pH of the aqueous carrier fluid (AC) in the free-flowing composition (FC) is generally in the range from 0 to 12. The pH of the aqueous carrier fluid (AC) in the free-flowing composition (FC) is generally matched to the water-soluble polymer (P) which coats the hydroreactive metal component (MC) in the solid component (SC).

The density of the aqueous carrier fluid (AC) is generally in the range from 1 g/cm³ to 3 g/cm³.

As component (B), the free-flowing composition (FC) comprises at least one solid component (SC) comprising a hydroreactive metal component (MC) coated by a water-soluble polymer (P).

The hydroreactive metal components (MC) used may be one or more metals, or else metal alloys. “Hydroreactive” is understood in the present context to mean that the metal component can react with water in an exothermic oxidation reaction to give the corresponding metal oxide and hydrogen with release of energy.

This exothermic oxidation reaction is described hereinafter using the example of the oxidation of aluminum. The oxidation of aluminum with water follows the following reaction equation

2Al+3H₂O→Al₂O₃+3H₂+heat

2 mol of aluminum and 3 mol of water thus give rise to 1 mol of aluminum oxide, 3 mol of hydrogen and heat.

The water which enters into an exothermic oxidation reaction with the hydroreactive metal component (MC) may originate exclusively from the aqueous carrier fluid (AC). If the underground deposit comprises water, called formation water, the free-flowing composition (FC) can also mix below ground with the formation water present in the underground deposit. In this case, the exothermic oxidation reaction takes place both with water from the aqueous carrier fluid (AC) and with formation water. Formation water is understood in the present context to mean water present in the underground deposit. This may be water originally present in the deposit. Formation water is also understood to mean water which has been introduced into the underground deposit by steps for secondary or tertiary mineral oil production before the introduction of the free-flowing composition (FC).

The hydroreactive metal component (MC) preferably comprises at least one metal selected from the group consisting of aluminum, magnesium and calcium. The present invention thus also provides a free-flowing composition wherein the hydroreactive metal component (MC) comprises at least one metal selected from the group consisting of aluminum, magnesium and calcium.

The hydroreactive metal component (MC) used may be exactly one metal. It is also possible to use mixtures or alloys of two or more metals.

In one embodiment, the hydroreactive metal component (MC) comprises 85% by weight of aluminum, preferably 89.0 to 97.5% by weight of aluminum, based in each case on the total weight of the hydroreactive metal component (MC). The present invention thus also provides a free-flowing composition wherein the hydroreactive metal component (MC) comprises at least 85% by weight of aluminum, based on the total weight of the metal component.

In one embodiment, the solid component (SC) comprises only aluminum as the hydroreactive metal component (MC).

In a further embodiment, the solid component (SC) comprises only magnesium as the hydroreactive metal component (MC).

In a further embodiment, the solid component (SC) comprises an alloy comprising at least aluminum and gallium as the hydroreactive metal component (MC). The present invention thus also provides a free-flowing composition (FC) in which the hydroreactive metal component (MC) is a metal alloy comprising aluminum and gallium. The present invention thus also provides a free-flowing composition (FC) wherein the hydroreactive metal component (MC) is a metal alloy comprising aluminum and gallium.

In a particularly preferred embodiment, the solid component (SC) comprises an alloy comprising aluminum, gallium, indium and tin as the hydroreactive metal component (MC).

If a metal alloy is used as the hydroactive metal component (MC) in the solid component (SC), the hydroactive metal component (MC) preferably has the following composition: 89 to 97.5% by weight of aluminum, 1 to 5% by weight of gallium, 1 to 3% by weight of indium and 0.5 to 3% by weight of tin, where the percentages by weight are each based on the total weight of the hydroreactive metal component (MC) and the sum of the proportions by weight adds up to 100% by weight.

The present invention thus also provides a free-flowing composition (FC) wherein the hydroreactive metal component (MC) is a metal alloy comprising 89.0 to 97.5% by weight of aluminum, 1 to 5.0% by weight of gallium, 1 to 3.0% by weight of indium, 0.5 to 3.0% by weight of tin, where the percentages by weight are each based on the total weight of the hydroreactive metal component (MC).

The total amount of hydroreactive metal component (MC) which may be present in the solid component (SC) is generally in the range from 5 to 90% by weight, preferably in the range from 70 to 90% by weight, based in each case on the total weight of the solid component (SC).

The present invention thus also provides a free-flowing composition (FC) wherein the solid component (SC) comprises 5 to 90% by weight of the hydroreactive metal component (SC), based on the total weight of the solid component (SC).

The hydroreactive metal components (MC) present in the solid component (SC) may have an oxide layer (passivation layer). It is also possible to use a hydroreactive metal component (MC) which does not have an oxide layer (passivation layer).

In the solid component (SC), the hydroreactive metal component (MC) is coated by a water-soluble polymer (P). “Water-soluble polymer (P)” is understood in accordance with the invention to mean both “readily water-soluble” polymers (P) and “sparingly water-soluble” polymers (P). The term “water-soluble” means that 1 to 1000 g of water are required per g of polymer (P) for a solution of the polymer (P) in water at 20° C.

The term “readily water-soluble” means that 1 to 30 g of water are required per g of polymer (P) for a solution of the polymer (P) in water at 20° C. The inventive readily water-soluble polymers (P) are water-soluble over the entire pH range.

The term “sparingly water-soluble” comprises low-solubility, sparingly soluble, and also virtually insoluble substances and means that from more than 30 g to 1000 g of water are required per g of polymer (P) for a solution of the polymer (P) in water at 20° C. In the case of virtually insoluble polymers (P), at least 10 000 g of water are required per g of polymer (P). Also listed among the sparingly water-soluble polymers (P) are those polymers (P) which are not soluble over the full pH range but have a pH-dependent solubility.

Preference is given to readily water-soluble and sparingly water-soluble polymers (P).

Suitable readily water-soluble polymers (P) are, for example, water-soluble homo- and copolymers of N-vinylpyrrolidone. For instance, suitable homopolymers are those having K values according to Fikentscher of 10 to 100, especially K12, K15, K30 K60, K90. In the case of the copolymers of N-vinylpyrrolidone, suitable copolymers are particularly those with vinyl acetate, preferably those having a weight ratio of N-vinylpyrrolidone (NVP) to vinyl acetate (VAc) of 60:40 to 80:20, especially the copolymer of NVP/VAc in a weight ratio of 60:40 designated as copovidone according to Pharm. Eur. and the US Pharmacopeia.

Additionally suitable as readily water-soluble polymers (P) are polyvinyl alcohols which, as homopolymers, are typically obtained by hydrolysis of polyvinyl acetate.

Equally suitable as polymers (P) are graft polymers based on polyethers as the graft base. Such graft copolymers can be obtained by free-radical polymerization of vinyl monomers in the presence of polyethers. Suitable vinyl monomers are, for example, N-vinyllactam monomers such as N-vinylpyrrolidone or N-vinylcaprolactam or mixtures thereof. Additionally suitable as vinyl monomers are vinyl ethers or vinyl esters, especially vinyl acetate. In the case of graft copolymers which are obtained using vinyl acetate, some or all of the ester groups may also be in hydrolyzed form. In addition, acrylates or methacrylates are also suitable as comonomers. Preferentially suitable are polyvinyl alcohol-polyethylene glycol graft copolymers, or graft copolymers obtainable by free-radical polymerization of a mixture of polyethylene glycol, N-vinylcaprolactam and/or vinyl acetate. Such graft polymers are commercially available as Kollicoat® IR or Soluplus®, from BASF.

Further useful readily water-soluble polymers (P) are polyalkylene glycols, for example polyethylene glycols, ethylene glycol-propylene glycol block copolymers, hydroxyalkylated celluloses, for example hydroxypropyl methyl cellulose, hydroxypropyl cellulose, hydroxyethyl cellulose, polysaccharides, for example carragenans, pectins, xanthans or alginates.

Sparingly water-soluble polymers (P) in the context of the invention are uncharged sparingly soluble polymers (P), anionic sparingly soluble polymers (P) or basic sparingly soluble polymers (P).

Uncharged sparingly soluble polymers (P) are understood to mean those polymers which are sparingly water-soluble or merely swellable in water over the entire pH range from 1 to 14. Suitable sparingly soluble polymers are, for example: uncharged or essentially uncharged methacrylate copolymers. These may consist especially of at least 95%, especially at least 98%, preferably at least 99%, especially to an extent of at least 99% and more preferably to an extent of 100% by weight of free-radically polymerized (meth)acrylate monomers having uncharged radicals, especially C₁- to C₄-alkyl radicals.

Suitable (meth)acrylate monomers having uncharged radicals are, for example, methyl methacrylate, ethyl methacrylate, butyl methacrylate, methyl acrylate, ethyl acrylate, butyl acrylate. Preference is given to methyl methacrylate, ethyl acrylate and methyl acrylate. It is possible for small proportions of less than 5% preferably not more than 2% and more preferably not more than 1 or 0.05 to 1% by weight of methacrylate monomers having anionic radicals, for example acrylic acid and/or methacrylic acid, to be present. Suitable examples are uncharged or virtually uncharged (meth)acrylate copolymers formed from 20 to 40% by weight of ethyl acrylate, 60 to 80% by weight of methyl methacrylate and 0 to less than 5%, preferably 0 to 2% or 0.05 to 1% by weight (Eudragit(R) N E type). Eudragit N E is a copolymer formed from 30% by weight of ethyl acrylate and 70% by weight of methyl methacrylate.

Further suitable sparingly soluble (meth)acrylate copolymers are, for example, polymers which are soluble or swellable independently of the pH and are suitable for medicament coatings.

The sparingly soluble polymer (P) may be a polymer formed from 98 to 85% by weight of C₁- to C₄-alkyl esters of acrylic acid or of methacrylic acid and 2 to 15% by weight of (meth)acrylate monomers having a quaternary ammonium group, or may be a mixture of several polymers from this substance class.

The sparingly soluble polymer (P) may also be a polymer formed from 97 to more than 93% by weight of C₁- to C₄-alkyl esters of acrylic acid or of methacrylic acid and 3 to less than 7% by weight of (meth)acrylate monomers having a quaternary ammonium group (Eudragit(R) RS type). Preferred C₁- to C₄-alkyl esters of acrylic acid or of methacrylic acid are methyl acrylate, ethyl acrylate, butyl acrylate, butyl methacrylate and methyl methacrylate. A particularly preferred (meth)acrylate monomer having quaternary ammonium groups is 2-trimethylammonioethyl methacrylate chloride. An example of a suitable copolymer comprises 65% by weight of methyl methacrylate, 30% by weight of ethyl acrylate and 5% by weight of 2-trimethylammonioethyl methacrylate chloride (Eudragit RS).

The sparingly soluble polymer (P) may be a polymer formed from 93 to 88% by weight of C₁- to C₄-alkyl esters of acrylic acid or of methacrylic acid and 7 to 12% by weight of (meth)acrylate monomers having a quaternary ammonium group (Eudragit RL type). A specifically suitable copolymer comprises, for example, 60% by weight of methyl methacrylate, 30% by weight of ethyl acrylate and 10% by weight of 2-trimethylammonioethyl methacrylate chloride (Eudragit(R) RL).

The solid component (SC) may also comprise a polyvinyl acetate as the sparingly soluble polymer (P). Suitable polyvinyl acetates are, for example, the homopolymers of vinyl acetate. Additionally suitable are sparingly soluble polyvinyl acetate copolymers, for example water-insoluble copolymers of vinyl acetate and N-vinylpyrrolidone. Commercially available suitable polyvinyl acetates are, for example, Kollicoat(R) SR 30D or Kollidon(R) SR.

Suitable sparingly soluble polymers (P) are also alkyl celluloses, for example ethyl cellulose, and uncharged cellulose esters, for example cellulose acetate butyrate.

In addition, it is also possible to use anionic sparingly soluble polymers (P). Anionic polymers are preferably understood to mean polymers having at least 5%, more preferably 5 to 75%, of monomer radicals having anionic groups. Preference is given to anionic (meth)acrylate copolymers. Suitable commercially available (meth)acrylate copolymers having anionic groups are, for example, the Eudragit(R) products L, L100-55, S and FS.

Suitable anionic (meth)acrylate copolymers are, for example, polymers formed from 25 to 95% by weight of C₁- to C₄-alkyl esters of acrylic acid or of methacrylic acid and 5 to 75% by weight of (meth)acrylate monomers having an anionic group. Corresponding polymers are, according to the content of anionic groups and the character of the further monomers, water-soluble at pH values above pH 5.0 and hence also soluble in gastric juice. In general, the proportions mentioned add up to 100% by weight.

A (meth)acrylate monomer having an anionic group may, for example, be acrylic acid, but preferably methacrylic acid. Additionally suitable are anionic (meth)acrylate copolymers formed from 40 to 60% by weight of methacrylic acid and 60 to 40% by weight of methyl methacrylate or 60 to 40% by weight of ethyl acrylate (Eudragit L or Eudragit L1 00-55 products). EUDRAGIT L is a copolymer formed from 50% by weight of methyl methacrylate and 50% by weight of methacrylic acid.

Eudragit L1 00-55 is a copolymer formed from 50% by weight of ethyl acrylate and 50% by weight of methacrylic acid. Eudragit L 30D-55 is a dispersion comprising 30% by weight of Eudragit L 100-55.

Equally suitable are anionic (meth)acrylate copolymers formed from 20 to 40% by weight of methacrylic acid and 80 to 60% by weight of methyl methacrylate

(Eudragit(R) S product). Additionally suitable are, for example, anionic (meth)acrylate copolymers consisting of 10 to 30% by weight of methyl methacrylate, 50 to 70% by weight of methyl acrylate and 5 to 15% by weight of methacrylic acid (Eudragit(R) FS product).

Eudragit FS is a copolymer formed from 25% by weight of methyl methacrylate, 65% by weight of methyl acrylate and 10% by weight of methacrylic acid. Eudragit FS 30 D is a dispersion comprising 30% by weight of Eudragit(R) FS. The copolymers consist preferably essentially to exclusively of the monomers methacrylic acid, methyl acrylate and ethyl acrylate in the proportions specified above.

The solid component (SC) may, in accordance with the invention, comprise exactly one polymer (P). It is also possible to use a mixture of two or more polymers (P).

Preferably, however, the solid component (SC) comprises at least one of the above-described readily water-soluble polymers (P).

The present invention thus also provides a free-flowing composition (FC) according to any of claims 1 to 11, wherein the solid component (SC) comprises, as the water-soluble polymer (P), at least one polymer selected from the group consisting of polyethylene oxide, polypropylene oxide, polyvinylpyrrolidone, polyvinyl alcohol and polyvinyl acetate.

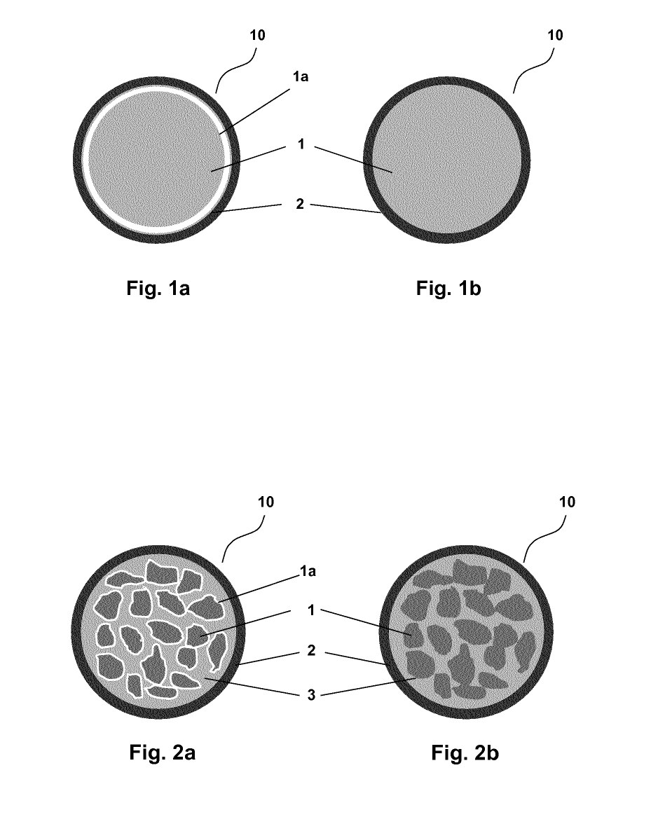

There is a multitude of options for the configuration of the solid component (SC). Some preferred configurations of the solid component (SC) are illustrated in detail by way of example hereinafter with reference to FIGS. 1 (a, b), 2 (a, b), 3 (a, b), 4 and 5.

In the figures, the reference numerals have the following meanings:

1 hydroreactive metal component (MC)

1a oxide layer (passivation layer)

2 polymer (P)

2a further polymer (P)

3 gas-filled intermediate space

10 solid component (SC)

The individual figures show:

The figures show cross sections through different embodiments of the solid component (SC) 10.

FIG. 1a)

The solid component (SC) 10 has a single core 1 composed of a hydroreactive metal component (MC). The hydroreactive metal component (MC) has been coated with a passivation layer 1a. The hydroreactive metal component (MC) used as the core 1 is enveloped by a polymer (P) 2.

FIG. 1b)

The solid component (SC) 10 has a single core 1 composed of a hydroreactive metal component (MC). In contrast to FIG. 1a) the hydroreactive metal component (MC) does not have a passivation layer 1a. The hydroreactive metal component (MC) used as the core 1 is likewise enveloped by a polymer (P) 2.

FIG. 2a)

The solid component (SC) 10 comprises, as a core, a multitude of hydroreactive metal components (MC) 1. These hydroreactive metal components (MC) 1 are in the form of a conglomerate. The individual metal components (MC) 1 are partly surrounded by gas-filled intermediate spaces 3 and have a passivation layer 1a). The conglomerate is encapsulated with an outer shell of polymer (P) 2.

FIG. 2b)

The solid component (SC) 10 in FIG. 2b) differs from the solid component (SC) 10 in FIG. 2a) in that the hydroreactive metal components (MC) 1 do not have a passivation layer 1a.

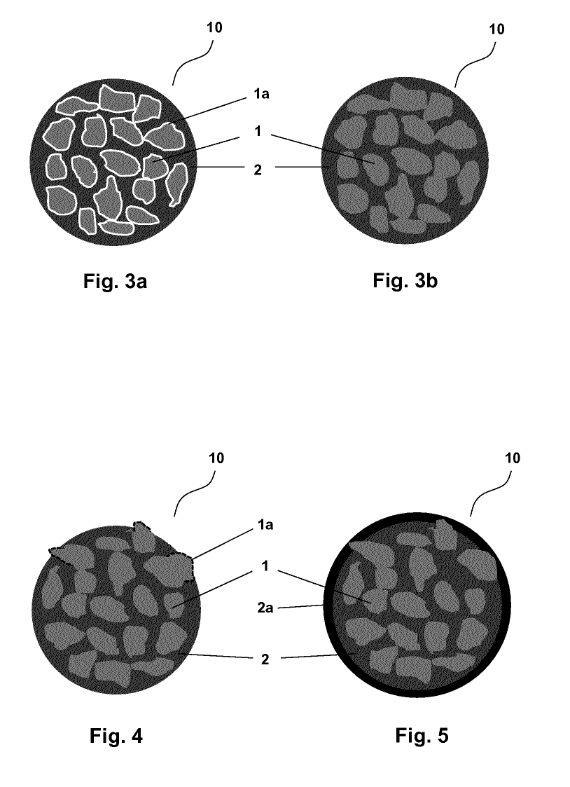

FIG. 3a)

The solid component (SC) 10 comprises a multitude of hydroreactive metal components (MC) 1 in the form of a dispersion. The metal components (MC) 1 have a passivation layer 1a. The solid component (SC) 10 is in the form of a dispersion. The hydroreactive metal components (MC) 1 form the disperse phase. The polymer 2 forms the continuous phase.

FIG. 3b)

The solid component (SC) 10 in FIG. 3b) differs from the solid component (SC) 10 in FIG. 3b) in that the hydroreactive metal components (MC) 1 do not have a passivation layer 1a.

FIG. 4

FIG. 4 shows a further embodiment of the solid component (SC) 10 according to FIG. 3a). Some hydroreactive metal components (MC) 1 are not fully enveloped by the polymer 2 in FIG. 4. The regions of the hydroreactive metal components (MC) 1 not enveloped by the polymer 2 have a passivation layer 1a).

FIG. 5

FIG. 5 shows a further configuration of the solid component (SC) 10 according to FIG. 3b). In order to prevent the formation of a passivation layer on the regions of the hydroreactive metal components (MC) 1 not enveloped by the polymer 2, the solid component (SC) 10 has an outer shell of a further polymer (P) 2a.

The shape of the solid component (SC) can be selected freely and depends essentially on the method by which the solid component (SC) has been produced. The solid components (SC) need not necessarily be spherical. The shape of the hydroreactive metal component (MC) too can be selected freely and depends essentially on the method by which the hydroreactive metal component (MC) has been produced. The hydroreactive metal components (MC) need not necessarily be spherical.

The solid component (SC) is suspended in the aqueous carrier fluid (AC). The size of the solid component (SC) may likewise vary within wide ranges. The size of the solid component (SC) is generally in the range from 0.3 to 10 mm, preferably in the range from 0.5 to 5 mm. The solid component (SC) is larger than the hydroreactive metal component (MC) used.

The present invention thus also provides a free-flowing composition (FC) wherein the solid component (SC) in the aqueous carrier fluid (AC) is in particulate form, the particle size being in the range from 0.3 to 10 mm.

The solid component (SC) generally has a density in the range from 1 to 5 g/cm³, preferably in the range from 1 to 2 g/cm³.

The hydroreactive metal component (MC) is preferably used in particulate form. The particle size of the hydroreactive metal component (MC) is generally 20 nm to 1000 μm, preferably 20 nm to 500 μm and more preferably 50 nm to 50 μm. The particle size of the hydroreactive metal component (MC) may thus be in the μm range (μ metal) or in the nm range (n metal). The industrial manufacture of the hydroreactive metal component (MC) is known and can be effected, for example, by means of vibratory mills or roll mills.

The invention thus also provides a free-flowing composition (FC) wherein the hydroreactive metal component (MC) in the solid component (SC) is in particulate form, the particle size of the hydroreactive metal component (MC) being in the range from 20 nm to 1000 μm.

The hydroreactive metal components (MC) used may be those having a passivation layer or those lacking a passivation layer. Hydroreactive metal components (MC) lacking a passivation layer are also referred to as active hydroreactive metal components (aMC). Hydroreactive metal components (MC) having a passivation layer are also referred to passive hydroreactive metal components (pMC).

Whether the solid component (SC) comprises hydroreactive metal components (MC) having or lacking a passivation layer can be controlled via the production method. If the hydroreactive metal component (MC) is produced, for example, in the presence of atmospheric oxygen, the hydroreactive metal components (MC) generally form a passivation layer.

If active hydroreactive metal components (aMC) are to be used, it is therefore necessary to produce the hydroreactive metal components (MC) with exclusion of atmospheric oxygen. In this case, the production is generally effected in the presence of an inert gas, for example nitrogen. If the active hydroreactive metal component (aMC) is produced in a vibratory mill or a roll mill, the milling system is operated under protective gas, for example nitrogen. For production of the solid component (SC), it is necessary here too subsequently to work under a protective gas atmosphere.

If the hydroreactive metal component (MC) used is a metal alloy which, as described above, comprises aluminum, gallium and optionally indium and tin in the above-described percentage ratios by weight, working under protective gas atmosphere is not absolutely necessary, since these metal alloys, even in the presence of atmospheric oxygen, do not form a passivation layer under standard temperature conditions in the range from 0 to 30° C.

It will be appreciated that it is necessary to work with exclusion of moisture and water in the course of production of the solid component (SC).

For enveloping of the hydroreactive metal component (MC) with a water-soluble polymer (P), it is possible to use known coating methods.

The coating method is also guided by the nature of the solid component (SC) which is to be produced. For production of the solid components (SC) which, as described in FIG. 1, comprise only a single core of a hydroreactive metal component (MC), what are called drum coating systems are suitable. In this case, the hydroreactive metal component (MC) is first comminuted as described above and then enveloped with a polymer (P) in the drum coating system.

If solid components (SC) which, as described in FIG. 2, have a multitude of hydroreactive metal components (MC) and are encapsulated by a polymer shell are to be produced, the particulate hydroreactive metal components (MC) are used in the form of conglomerates, i.e. in the form of an assembly of a multitude of hydroreactive metal components (MC) separated from one another by gas-filled intermediate spaces (3). These conglomerates can be produced by known processes, for example by compression of the hydroreactive metal components (MC). If solid components are produced according to FIG. 2a), comprising passive hydroreactive metal components (pMC), the intermediate space 3 may comprise air. If solid components according to FIG. 2b) are produced, comprising active hydroreactive metal components (aMC), the gas-filled intermediate space 3 generally comprises an inert gas, for example nitrogen. The coating of the conglomerates, i.e. the encapsulation with the polymer shell (2), can likewise be effected, for example, by a drum coating system.

In a preferred embodiment, the solid component (SC) is used in the form of a dispersion. This embodiment is shown by way of example in FIGS. 3a), 3b), 4 and 5. In this embodiment, hydroreactive metal components (MC) are dispersed in the polymer (P). The hydroreactive metal components (MC) here form the disperse phase, and the polymer (P) forms the continuous phase of the dispersion. The continuous phase is also referred to as the dispersion medium. The disperse phase is also referred to as the dispersed substance or dispersoid.

The present invention thus also provides a free-flowing composition (FC) wherein the solid component (SC) is a dispersion in which the water-soluble polymer (P) forms the continuous phase and the hydroreactive metal component (MC) the disperse phase.

Preferred polymers (P) are therefore thermoplastic polymers.

For production of solid components (SC) in the form of a dispersion, as described above, the hydroreactive metal components (MC) are first produced. These are subsequently mixed into a melt of the polymer (P). The mixing-in can be effected, for example, by means of an extruder. Subsequently, the polymer melt comprising the hydroreactive metal components (MC) in dispersed form is cooled. After the cooling, this polymer dispersion (comprising the hydroreactive metal component (MC) (MC) as the disperse phase and the polymer (P) as the continuous phase) is comminuted to produce the solid component (SC). This can be accomplished, for example, by means of a granulator.

The polymer melt comprising the hydroreactive metal components (MC) in dispersed form can also be processed to give the solid components/granules by atomization or by droplet production and simultaneous cooling in a column.

The methodology for production of the above-described solid components (SC) is described, for example, in EP 2 463 327, to which reference is hereby made.

For this purpose, the polymer (P) is mixed together with the hydroreactive metal component (MC), for example in an extruder, and subsequently forced through a perforated plate into a cooling medium in which the polymer melt solidifies and the solid component (SC) is formed.

Suitable apparatuses and cooling media are likewise described in EP 2 463 327.

Suitable polymers (P) mentioned here merely by way of example include Soluplus®, from BASF SE: graft polymer composed of PEG 6000/N-vinylcaprolactam/vinyl acetate, mean molecular weight (MW) determined by gel permeation chromatography 90 000-140 000 g/mol; Kollidon® VA 64, from BASF SE, a copolymer of N-vinylpyrrolidone and vinyl acetate in a weight ratio of 60:40, referred to in the pharmacopeias as “copovidone”; Kollidon® SR: co-processed mixture of polyvinyl acetate, polyvinylpyrrolidone K30 (povidone according to Pharm. Eur. or USP), sodium laurylsulfate and silica in a weight ratio of 80/19/0.8/0.2; PEG 1500: polyethylene glycol, MW 1500 g/mol; PEG 6000: polyethylene glycol, MW 6000 g/mol.

Examples of suitable apparatuses include ZSK 25 rotary twin-screw extruders (Werner & Pfleiderer) having a metering device and a melt pump; underwater pelletization (GALA-LPU, from Gala, Xanten) having a heated perforated plate having a bore diameter of 3.2 mm. Knifes: 5 blades, speed 800-2000 rpm; centrifuge for separation of the cooling medium from pellets (grid: 1.9 mm, speed 1500 rpm).

A suitable cooling medium is Weissoel W118 (Fuchs Petrolub) having a viscosity of 16 mm²/s at 40° C., measured to DIN 51562.

If the production of the solid component (SC) is executed with exclusion of oxygen, or the above-described metal alloys comprising aluminum, gallium and optionally indium and tin are used, solid components (SC) comprising active hydroreactive metal components (aMC) are obtained. FIGS. 3b), 4 and 5 show, by way of example, solid components (SC) comprising active hydroreactive metal components (aMC) in dispersed form.

If the production of the solid components (SC) is executed in the presence of atmospheric oxygen, solid components (SC) comprising passive hydroreactive metal components (pMC) are obtained. FIG. 3a) shows, by way of example, a solid component (SC) comprising passive hydroreactive metal component (pMC) in dispersed form.

If, in the case of production of the solid components (SC) in the form of a dispersion, partial regions of the active hydroreactive metal components (aMC) are not enveloped by polymer (P), a passivation layer generally forms on these partial regions on subsequent contact with atmospheric oxygen. This case is shown by way of example in FIG. 4. The partial regions having a passivation layer are indicated by the reference numeral 1a.

If the formation of a passivation layer on the unenveloped partial regions is to be prevented, these partial regions can be enveloped by a further polymer (P) (2a). For this purpose, the solid component (SC) in which partial regions of the active hydroreactive metal components (aMC) are not enveloped by polymer (P), is enveloped by a further polymer layer (2a). This further polymer layer (2a) may be a polymer (P) other than the polymer of the continuous phase (of the dispersion medium). It is also possible to use, as the further polymer (2a), a polymer (P) identical to the polymer of the continuous phase (2).

Preference is given to solid components (SC) having the active hydroreactive metal components (aMC), i.e. hydroreactive metal components (MC) lacking a passivation layer.

The present invention thus also provides a free-flowing composition (FC) wherein the solid component (SC) comprises an active hydroreactive metal component (aMC) which does not have a passivation layer.

In this context, it is not absolutely necessary that all hydroreactive metal components (MC) present in the solid component (SC) are present without a passivation layer. It is generally sufficient when at least 50% by weight, preferably at least 80% by weight and more preferably at least 90% by weight of the hydroreactive metal components are in the form of the active hydroreactive metal components (aMC), based in each case on the total weight of the hydroreactive metal components (MC) present in the solid component (SC).

These solid components (SC) have the advantage that, after dissolution or decomposition of the polymer (P), the exothermic oxidation reaction of the active hydroreactive metal component (aMC) sets in directly. As a result of this, through the choice of the amount or layer thickness of the polymer (P) in the solid component (SC), it is possible to control the duration before onset of the exothermic oxidation reaction.

According to the type and amount of the polymer (P) in the solid component (SC), the duration between the contacting of the solid component (SC) with water and the onset of the exothermic oxidation reaction may be a few minutes to a few days. In general, the duration between contacting and onset of the exothermic oxidation reaction is 2 hours to 10 days, preferably 2 hours to 1 day, more preferably 2 hours to 4 hours.

The duration which is required for dissolution of the polymer (P) additionally depends on the temperature. At higher temperatures, the polymer (P) is dissolved more rapidly, and the duration before onset of the exothermic oxidation reaction is generally shorter.

The duration before onset of the exothermic oxidation reaction can additionally be controlled via the nature and amount of the water-soluble polymer (P) used. For a longer duration before onset of the exothermic oxidation reaction, polymers (P) having a lower water solubility are generally used.

The free-flowing composition (FC) comprises generally from 5 to 70% by weight of the solid component (SC) and 30 to 70% by weight of the aqueous carrier fluid (AC), and optionally 0 to 65% by weight of a proppant (PP), based in each case on the total weight of the free-flowing composition (FC), where the sum of the percentages by weight is 100% by weight. This composition is preferred if the free-flowing composition (FC) is used as fracking fluid.

The present invention thus also provides a free-flowing composition (FC) wherein the free-flowing composition (FC) comprises 5 to 70% by weight of the solid component (SC), 30 to 70% by weight of the aqueous carrier fluid (AC) and 0 to 65% by weight of a proppant (PP), based in each case on the total weight of the free-flowing composition (FC).

The present invention further provides for the use of a free-flowing composition (FC) for hydraulic fracking of the underground deposits.

For this purpose, the free-flowing composition (FC) is injected into the underground formation at a pressure sufficient to bring about a fracture event in the surrounding rock.

If proppant (PP) is used, it is possible to use, for example, sand or proppant. The proppant (PP) preferably has a density similar to that of the solid component (SC), for example a density in the range from 1 to 5 g/cm³, preferably in the range from 1 to 3 g/cm³. The particle size of the proppant is generally in the range from 0.3 to 10 mm.

The inventive free-flowing composition (FC) can be used for thermal treatment of cavities in underground deposits. The underground deposits are preferably mineral oil and/or natural gas deposits.

The present invention thus also relates to a method for thermal treatment of an underground deposit into which at least one well has been sunk, comprising the method steps of

a) producing a fluid raw material from the underground deposit through at least one well,

b) stopping the production of the fluid raw material from the underground deposit,

c) injecting the inventive free-flowing composition (FC) through at least one well into the underground deposit,

d) waiting for a rest phase in which the polymer (P) is dissolved and the exothermic oxidation reaction of the hydroreactive metal component (MC) with water takes place,

e) continuing the production of the fluid raw material from the underground deposit through at least one well.

The present invention also relates to a method for thermal treatment of an underground mineral oil deposit into which at least one well has been sunk, comprising the method steps of

a) producing mineral oil and/or natural gas from the underground mineral oil deposit through at least one well,

b) stopping the production of mineral oil and/or natural gas from the underground mineral oil deposit,

c) injecting the inventive free-flowing composition (FC) through at least one well into the underground mineral oil deposit,

d) waiting for a rest phase in which the polymer (P) is dissolved and the exothermic oxidation reaction of the hydroreactive metal component (MC) with water takes place,

e) continuing the production of mineral oil and/or natural gas from the underground mineral oil deposit through at least one well.

The above details and preferences relating to the free-flowing composition (FC) apply correspondingly to the methods for thermal treatment.

Method step a) is generally performed until a drop in the production rate of the fluid raw material, preferably mineral oil and/or natural gas, is detected. The drop in the production rate can be caused, for example, by high-viscosity substances such as paraffins, high-viscosity mineral oils or bitumen (asphaltenes) which lower the hydrodynamic communication between productive stratum and well.

The actual thermal treatment thus takes place in method steps c) and d). The evolution of heat in combination with the formation of gases removes the deposits in method step d), and the hydrodynamic communication is improved. The thermal treatment in method step d) can additionally form new cracks and fissures in the underground deposit.

The present invention thus also provides for the use of the inventive free-flowing composition (FC) for thermal treatment of underground deposits. The thermal treatment removes the above-described deposits of high-viscosity substances; in addition, new cracks and fissures can form in the underground deposit.

The present invention thus also provides for the use of the inventive free-flowing composition (FC) for removal of high-viscosity deposits from underground deposits, preferably of high-viscosity deposits selected from the group consisting of paraffins, high-viscosity mineral oils and bitumen.

The present invention thus also further provides for the use of the inventive free-flowing composition (FC) for fracking of the rock surrounding a well in an underground deposit, preferably in a natural gas or mineral oil deposit. “Fracking” is understood to mean the occurrence of a fracture event in the rock surrounding the well in the underground formation, that is brought about by the exothermic oxidation reaction of the hydroreactive metal component (MC) with water. The fracture event(s) give(s) rise to new cracks and fissures in the rock surrounding the well in the underground formation.

In one embodiment, the free-flowing composition (FC) comprises a solid component (SC) comprising, as the hydroreactive metal component (MC), magnesium, preferably at least 50% by weight of magnesium, more preferably at least 90% by weight of magnesium and especially preferably at least 99% by weight of magnesium, based in each case on the total weight of the hydroreactive metal component (MC).

In this embodiment, the free-flowing composition (FC) can be used as a chemical detonator for detonation of explosives. The prior art describes methods in which free-flowing explosives are injected through wells into underground deposits. The detonation of the explosives forms new cracks, fissures and cavities in the underground deposit. The explosive is generally detonated by an electrical or chemical detonator.

Chemical detonators described in the prior art are mixtures based on uncoated magnesium granules and aqueous hydrochloric acid. In the prior art, uncoated magnesium granules are introduced into the well in the form of an aqueous suspension and are subsequently mixed underground with aqueous acid in the well. This is disadvantageous since magnesium can already undergo uncontrolled oxidation with water.

The present invention thus also provides for the use of the inventive free-flowing composition (FC) as a detonator, preferably as a detonator for free-flowing explosives, more preferably for free-flowing explosives which have been injected into underground deposits.

In a preferred embodiment, in the case of use of the free-flowing composition (FC) as a detonator, the aqueous carrier fluid (AC) used is an aqueous hydrochloric acid solution having a hydrochloric acid content in the range from 1 to 38% by volume, preferably in the range from 10 to 25% by volume, more preferably in the range from 15 to 20% by volume, and the solid component (SC) comprises magnesium as the hydroreactive metal component (MC), preferably at least 50% by weight of magnesium, more preferably at least 90% by weight of magnesium and especially preferably at least 99% by weight of magnesium, based in each case on the total weight of the hydroreactive metal component (MC).

The reaction of hydrochloric acid with magnesium gives rise to hydrogen and heat according to the following reaction equation:

2HCl+Mg=>MgCl₂+H₂+heat

The chemical reaction of one kilogram of magnesium with hydrochloric acid generates about 5000 kcal of heat, and the temperature of the detonation mixture reaches 600 to 800° C. This temperature reliably assures the detonation of the free-flowing explosive.

### EXAMPLES

The present invention is illustrated in detail by the examples which follow but is not restricted thereto.

### 1 Development of a Heavy Oil Deposit by In Situ Combustion

Oil can be produced from heavy oil deposits only at high temperatures and pressures. A horizontal production well is sunk into the oil-bearing geological stratum of an underground heavy oil deposit having a thickness of 40 to 50 meters and a deposit temperature of 85° C., and then perforated. In addition, an injection well is sunk into the heavy oil deposit.

A free-flowing composition (FC) is introduced into the heavy oil deposit through the injection well. This free-flowing composition (FC) is injected at a pressure sufficient to form gaps and cracks running vertically with respect to the injection well in the area surrounding the injection well. The free-flowing composition (FC) is thus used as a fracking fluid.

The free-flowing composition (FC) comprises, as the aqueous carrier fluid (AC), a 20% by weight aqueous solution of ammonium nitrate in water, and has been gelated with a polyacrylamide (viscosity 400 cP).

As the solid component (SC), the free-flowing composition comprises a dispersion of aluminum in polyvinylpyrrolidone (80% by weight of aluminum based on the total weight of SC).

In one tonne of free-flowing composition (FC), 300 kg of proppant and 100 kg of solid component (SC) are present (remainder: aqueous carrier fluid (AC)). Through the injection well, 700m³ of free-flowing composition (FC) are injected at a pressure of 800 atm in order to produce the fracks.

The period for dissolution of the polymer (P) is about 6 hours. Thereafter, the exothermic oxidation reaction of the aluminum and the decomposition of the ammonium nitrate set in with evolution of heat and gas. This reaction proceeds within a few minutes. Directly after the thermal oxidation reaction has ended, air is injected into the heated fracks through the injection well in order to start or to maintain the in situ combustion. The detonation surface corresponds to the surface of the fracks. In this way, a broad combustion front is achieved. Before the combustion front, the heavy oil is modified and produced conventionally.

The method can also be used for in situ incineration of shale oil or coal deposits.

### 2. Development of a Tight Gas Deposit

Tight gas deposits are understood to mean deposits in which natural gas is stored in small cavities with poor connection to one another between rock formations. Typically, such deposits are developed by conventional hydraulic fracturing. Because of the normally low gas pressure of tight gas deposits, the normal treatment methods described in the prior art lead to contamination of the deposit by the aqueous fracking fluids used for hydraulic fracturing, which has an adverse effect on the gas production rates.

According to the invention, for development of a tight gas deposit at a depth of 3 km having a deposit temperature of 105° C., a horizontal well is sunk. The length of the horizontal well section is 1.5 km. The horizontal well section is f racked repeatedly, the distance between the fracks being about 300 m. The fracks are produced using a free-flowing composition (FC) comprising water gelated with polyacrylamide as the aqueous carrier fluid (AC). The free-flowing composition (FC) additionally comprises ceramic proppant and a solid component (SC) comprising aluminum dispersed in a polyvinylpyrrolidone polymer (90% by weight of aluminum based on the total weight of SC). For every fracked section, 400 to 700 m3 of the aqueous carrier fluid (AC), 100 to 220 t of proppant and 10 to 20 t of the solid component (SC) are used.

After the injection of the free-flowing composition (FC) and the hydraulically induced formation of gaps and cracks (fracks), the well remains under pressure in order to prevent the flow of the free-flowing composition (FC) out of the hydraulically induced fracks. After 2 to 6 hours, an increase in pressure in the well is registered. This pressure increase indicates the commencement of the oxidation reaction between water and aluminum in the hydraulically induced fracks. As a result of the exothermic oxidation reaction, the temperature rises up to 900° C., which vaporizes or decomposes the water present in the aqueous carrier fluid (AC). At the same time, hydrogen forms, which originates from the oxidation reaction between aluminum and water. The abrupt rise in temperature and pressure results in formation of numerous further microcracks in the environment of the hydraulically induced fracks. The formation of these microcracks (gas fracturing) is promoted by the thermal shock in the rock. At the same time, the aluminum in the fracks forms aluminum oxide in the form of a highly porous slag having very good permeability to gases.

After the exothermic oxidation reaction has run its course, for example after a period of 1 to 2 days, the gas production from the tight gas deposit is continued by conventional methods. The method according to the invention results in a rise in the gas production rate by 20 to 200% compared to conventional processes based only on “hydraulic fracturing”.

In the course of performance of the method according to the invention, the only by-product formed is nontoxic aluminum oxide. It is possible to dispense with the chemical additives used in conventional hydraulic fracturing, for example gel breakers, biocides or clay stabilizers. The method according to the invention is thus uncontroversial in an environmental sense.

### 3. Thermal Treatment of a Mineral Oil Production Well

In a production well having a horizontal section having a length of 3 km, a decrease in the production rate is registered. The perforated well section has a length of 400 m. The internal diameter of the perforated well section was originally 10.05 cm. As a result of deposits of high-viscosity materials, the internal diameter of the perforated well section has been reduced by about 25%. For removal of the deposits and for stimulation of the production rates, the perforated well section is filled with the following composition (C):
40% by weight of ammonium nitrate,
20% by weight of urea,
5% by weight of glycerol,
0.03% by weight of glucan,
100% by weight of water.

This composition (C) can react exothermically. In this case, the ammonium nitrate acts as an oxidizing agent; urea and glycerol act as fuel (reducing agents). For burning of this composition (C), no atmospheric oxygen is thus needed. The detonation temperature of this composition (C) is about 500° C. In order to ensure reliable detonation of this composition (C), temperatures of about 600° C. are needed.

After introduction of the above-described (noninventive) composition (C) into the perforated well section, the latter is closed with a packer.

Subsequently, the inventive free-flowing composition (FC) is introduced into the perforated well section filled with the composition (C) as a detonator. The free-flowing composition (FC) used here is water as the aqueous carrier fluid (AC), and the solid component (SC) used is aluminum dispersed in polyvinylpyrrolidone (90% by weight of aluminum based on the total weight of SC). 35% by weight of the solid component (SC) is present In the free-flowing composition (FC), based on the total weight of the free-flowing composition (FC).

The free-flowing composition (FC) is used here for detonation of the composition (C). The volume of the free-flowing composition (FC) is 2.5% by volume of the composition (C) with which the perforated region of the production well has been filled.

For dissolution of the polymer (P) (polyvinylpyrrolidone), a period of 3 to 6 hours is required. Subsequently, the exothermic reaction between aluminum and the water present in the carrier fluid (AC) commences.

As a result of this, temperatures exceeding 600° C. are obtained locally, as a result of which the composition (C) comprising ammonium nitrate, urea, glycerol, glucan and water is detonated. This composition (C) reacts within 10 to 20 minutes, the reaction between ammonium nitrate with urea and glycerol releasing further heat. This destroys the deposits in the perforated region of the production well.

Subsequently, the well is flushed with water in order to discharge the detached deposit residues from the well.

Subsequently, oil production is continued by conventional methods.

The above-described method for thermal treatment of production wells can achieve increases in the production rate of 10 to 80% (based on the production rate before removal of the deposits).

1. A free-flowing composition (FC) comprising:
(A) an aqueous carrier fluid (AC) and
(B) a solid component (SC) comprising a hydroreactive metal component (MC) enveloped by a water-soluble polymer (P),
the solid component (SC) being suspended in the aqueous carrier fluid (AC) and, wherein the hydroreactive metal component (MC) comprises at least 85% by weight of aluminum, based on the total weight of the metal component (MC).

2. The free-flowing composition (FC) according to claim 1, wherein the solid component (SC) in the aqueous carrier fluid (AC) is in particulate form, the particle size being in the range from 0.3 to 10 mm.

3. The free-flowing composition (FC) according to claim 1, wherein the hydroreactive metal component (MC) in the solid component (SC) is in particulate form, the particle size of the hydroreactive metal component (MC) being in the range from 20 nm to 1000 μm.

4. The free-flowing composition (FC) according to claim 1, wherein the solid component (SC) is a dispersion in which the water-soluble polymer (P) forms a continuous phase and the hydroreactive metal component (MC) a disperse phase.

5. The free-flowing composition (FC) according to claim 1, wherein the solid component (SC) comprises 5 to 90% by weight of the hydroreactive metal component (MC), based on the total weight of the solid component (SC).

6. The free-flowing composition (FC) according to claim 1, wherein the hydroreactive metal component (MC) is a metal alloy comprising aluminum and gallium.

7. The free-flowing composition (FC) according to claim 1, wherein the hydroreactive metal component (MC) is a metal alloy comprising:
89.0 to 97.5% by weight of aluminum,
1 to 5.0% by weight of gallium,
1 to 3.0% by weight of indium, and
0.5 to 3.0% by weight of tin,
where the percentages by weight are each based on the total weight of the hydroreactive metal component (MC).

8. The free-flowing composition (FC) according to claim 1, wherein the free-flowing composition (FC) comprises:
5 to 70% by weight of the solid component (SC),
30 to 70% by weight of the aqueous carrier fluid (AC) and
0 to 65% by weight of a proppant (PP),
based in each case on the total weight of the free-flowing composition (FC).

9. The free-flowing composition (FC) according to claim 1, wherein the solid component (SC) comprises an active hydroreactive metal component (aMC) which does not have a passivation layer.

10. The free-flowing composition (FC) according to claim 1, wherein the solid component (SC) comprises, as the water-soluble polymer (P), at least one polymer selected from the group consisting of polyethylene oxide, polypropylene oxide, polyvinylpyrrolidone, polyvinyl alcohol, and polyvinyl acetate.

11. A method for thermal treatment of an underground deposit into which at least one well has been sunk, comprising the method steps of:
a) producing a fluid raw material from the underground deposit through at least one well,
b) stopping the production of the fluid raw material from the underground deposit,
c) injecting a free-flowing composition (FC) according to claims 1 through at least one well into the underground deposit,
d) waiting for a rest phase in which the water-soluble polymer (P) is dissolved and an exothermic oxidation reaction of the hydroreactive metal component (MC) with the water present in the aqueous carrier fluid takes place, and
e) continuing the production of the fluid raw material from the underground deposit through at least one well.

12. A method of thermal treatment comprising: obtaining the free-flowing composition (FC) according to claim 1 and injecting the FC into a well, an underground deposit, or a pipeline.

13. The free-flowing composition (FC) according to claim 1, which is effective as a detonator.
